(19) United States
(12) Patent Application Publication
(10) Pub. No.: US 2005/0005913 A1
(43) Pub. Date: Jan. 13, 2005

(54) High-pressure fuel injection pipe

(75) Inventors: Masayoshi Usui, Numazu-shi (JP); Kikuo Asada, Mishima-shi (JP); Teruhisa Takahashi, Mishima-shi (JP)

Correspondence Address: CASELLA & HESPOS, 274 MADISON AVENUE, NEW YORK, NY, 10016, US

(73) Assignee: Usui Kokusai Sangyo Kaisha Limited, Sunto-gun (JP)

(21) Appl. No.: 10/616,841

(22) Filed: Jul. 10, 2003

(51) Int. Cl. F02M 55/02

(52) U.S. Cl. 123/468

(57) ABSTRACT

A high pressure fuel injection pipe is provided for a diesel engine and has excellent internal pressure fatigue resisting characteristics, vibrational fatigue resisting characteristics and cavitation resisting property and sheet face flawing resisting property, and can be made thin and light in weight. In the high pressure fuel injection pipe, pipe extension and heat treatment are repeated by using a header manufactured by transformation induced plastic type strength steel, and processing for depositing residual austenite is then performed and final pipe extension processing is performed, and a joint portion is molded and bending processing is performed without performing perfect annealing at the size of a product.

### BACKGROUND OF THE INVENTION

1. Field of the Invention

The present invention mainly relates to a fuel injection pipe (including a feed pipe and an injection pipe for a common-rail injection system) used in a fuel supply path of a diesel internal combustion engine.

2. Description of the Prior Arts

For example, it is known as the fuel injection pipe for the diesel engine of this kind that a connecting head portion 12 of a conical shape with a head having an outside circumferential face arranged in an end portion of a thick wall steel pipe 11 as a linear sheet face 13 as shown in FIG. 1, or a connecting head portion 22 having an outside circumferential face arranged in an end portion of a thick wall steel pipe 21 as an arc sheet face 23 as shown in FIG. 2 is molded by buckling processing using pressing pressure in the axial core direction. using a punch member from the outward direction, etc.

In such a fuel injection pipe for the diesel engine, a steep pipe (STS370, 410 of JISG3455) of 340 N/mm² class to 410 N/mm² class in tensile stress has been generally used. However, as a cleaning technique is developed by exhaust gas regulation of the diesel engine, a technique for more perfectly setting the fuel within an engine cylinder by increasing the pressure of the fuel and injecting the fuel as fine particles, and cleaning the exhaust gas is adopted. Accordingly, a high internal pressure equal to or higher than the conventional 1200 bar is loaded in the fuel injection pipe. Therefore, high internal pressure fatigue strength is required. As its countermeasure, a high tensile steel pipe of 490 N/mm² class to 600 N/mm² class in tensile stress tends to be used.

Such a high tensile steel pipe is generally manufactured by drawing processing. With respect to the high tensile steel pipe manufactured by the drawing processing, when the steep pipe is manufactured by hot processing from an ingot, and is processed to a required size by the drawing processing (pipe extension) from its thick diameter pipe, there is a case in which a fine wrinkle flaw (defect) of about 100 μm in depth is generated on the inner face of the steel pipe. It is known that this wrinkle flaw is caused by the difference in the flow of a material between the outside and the inside generated when the pipe diameter is reduced by a die from the outside of the pipe at the pipe processing time, and the pipe is rolled by a plug from the inside. Namely, such a phenomenon is caused by the insufficiency of extension caused by approximately inverse proportion of the tension and the extension (ductility and processability). This phenomenon is greatly generated in the thick wall pipe. Since the inside wrinkles rolled by the plug also have small ductility, the inside wrinkles are left as flaw wrinkles. In particular, when a fine wrinkle flaw of about 100 μm in depth exists on the pipe inner face and a high internal pressure of 1200 bar to 1600 bar is repeatedly applied to the pipe interior, there is a possibility that fatigue breakdown is caused and the pipe bursts by stress concentration caused in this wrinkle flaw portion.

As such a countermeasure, there is conventionally a method for removing the above wrinkle flaw on the pipe inner circumferential face as a starting point of the internal pressure fatigue breakdown by a special cutting technique. However, the defect of the inner circumferential face as a starting point of the internal pressure fatigue breakdown can be removed by the special cutting, and internal pressure fatigue strength can be raised. However, it was not possible to bear a pressure of about 1600 bar or more from a limit of the strength of a material. In contrast to this, since no vibrational fatigue strength is almost raised, there is no effect with respect to the vibrational fatigue breakdown advanced with the outer surface as a starting point.

In contrast to this, there is a method (autofrettage method) for generating compression residual stress on the inner surface by applying the pressure to the pipe interior. However, in this method, there is a case in which the distribution of the residual stress is changed by subsequent elastic deformation, and is vanished. Further, when the compression residual stress is generated on the inner surface, the inner surface is processed and hardened, but the inner surface fatigue strength is insufficient approximately in the normal processing-hardening of a material. The vibrational fatigue is mainly advanced with-the outer surface of the pipe as a starting point, but no strength of the outer surface is improved at all. Therefore, no vibrational fatigue characteristics were improved at all.

The present invention is made to solve such conventional problems, and an object of the present invention is to provide a high pressure fuel injection pipe excellent in internal pressure fatigue resisting characteristics, vibrational fatigue resisting characteristics and cavitation resisting property, and also excellent in sheet face flawing resisting property and bending shape stable property, and made thin and light in weight.

### SUMMARY OF THE INVENTION

In a high pressure fuel injection pipe according to the one aspect in the present invention, pipe extension and heat treatment are repeated by using a header manufactured by trans formation induced plastic type strength steel having high tension in comparison with STS370, 410 of JISG3455, etc. without performing processing described later, and processing for depositing residual austenite is then performed and final pipe extension processing is performed, and the high tension is further raised by molding a joint portion and performing bending without performing perfect annealing at the size of a product so that internal pressure and bending fatigue strength are raised. In high pressure fuel injecting pipe according to another aspect of the present invention, pipe extension and heat treatment are repeated by using a header manufactured by transformation induced plastic type strength steel, and the header is finished at a product size via a final pipe extension process, and processing for depositing residual austenite is then performed, and a joint portion is molded and bending processing is performed, and the inner surface layer of a manufactured pipe body is plastically processed so that a martensitic transformation is induced and high strength is set by further raising high tension.

In high pressure fuel injecting pipe according to still another aspect in the present invention, flaw removal processing on the inner surface of a steel pipe having a transformation induced plastic type strength steel component and pipe extension processing are performed, and the steel pipe is finished at a predetermined desirable size and is then heated to 950° C. and is set to an austenite single layer and is then suddenly cooled, and austemper processing is performed at 350 to 500° C., and the inner surface is smoothed after the cooling, and a joint portion is then molded and bending processing is performed so that internal pressure and bending fatigue strength are raised. Further, the martensitic transformation is induced by performing plastic processing after the above bending processing, and high strength is set.

It is possible to use a method in which only the inner circumferential surface is plastically deformed (autofrettage-processed) by applying internal pressure in the above plastic processing. Further, cleaning processing of the inner surface may be performed at least once after the smoothing of the inner surface, the molding of the joint portion, or the bending processing.

### BRIEF DESCRIPTION OF THE DRAWINGS

FIG. 1 is a sectional view of a main portion showing one embodiment of a high pressure fuel injection pipe as an object of the present invention.

FIG. 2 is a sectional view of a main portion showing another embodiment of high pressure fuel injection pipe as an object of the present invention.

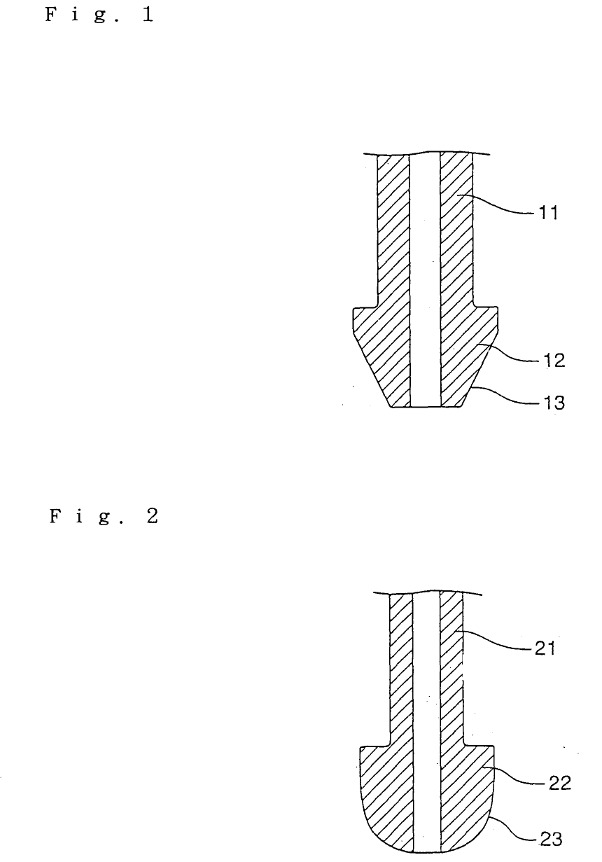

### DETAILED DESCRIPTION OF PREFERRED EMBODIMENTS

Transformation induced plastic type strength steel in the present invention is developed for the purpose of making a press molding part around a foot in a passenger car light in weight in recent years. This transformation induced plastic type strength steel is ferrite (α_{f})+bainite (α_{b})+γ_{R} composite texture steel [TRIP type Dual-Phase steel, TDP steel], and bainitic ferrite (α_{bf})+γ_{R} steel [TRIP type bainite steel, TB steel] in which press molding property is greatly improved by utilizing the strain induced transformation (TRIP) of residual austenite (γ_{R}).

Here, the transformation induced plasticity is the large extension of an austenite (γ) layer existing in a scientifically unstable state caused in transformation to martensite by adding mechanical energy.

Namely, the TRIP steel is steel in which the metallic texture of a mixture of the residual austenite and the bainite texture with the grain boundary of an α-layer as a center is obtained by taking a specific heat treatment in a certain limited plastic steel. As features of the TRIP steel having such a metallic texture, plastic deformation ability is high and the TRIP steel is high in strength and becomes hard since the TRIP steel becomes a martensite texture by processing.

Since the high pressure fuel injection pipe in the present invention is manufactured by the transformation induced plastic type strength steel having such characteristics, this high pressure fuel injection pipe has good processability during the processing and is smooth (there is no flaw) on the inner surface. Further, since a reduction at the extending time of the pipe can be set to be large, the number of extending times of the tube can be reduced. Further, the processing can be performed by a small pipe extending machine and a small die if the reduction is the same.

The injection pipe had the austenite (γ) texture. However, both hardness and tensile strength are improved by deposition of the processed induced martensite. Accordingly, internal pressure fatigue resisting characteristics, cavitation resisting property, the flawing resisting property of a sheet face, and bending shape stable property are excellent.

Further, the transformation induced plastic type strength steel has characteristics (TRIP phenomenon) in which the austenite of a locally deformed portion is transformed to hard martensite, and its portion is strengthened. Accordingly, in the case of the high pressure fuel injection pipe manufactured by this transformation induced plastic type strength steel, even when vibrational fatigue and internal pressure fatigue are advanced, its fatigue portion is strengthened by the above characteristics and resistance force for preventing breakdown of the pipe is generated. Therefore, the high pressure fuel injection pipe has long life in comparison with the conventional STS370, 410 of JISG3455.

In the present invention, the method for plastically deforming (autofrettage processing) only the inner circumferential surface by applying the internal pressure to a plastic processing means is used since residual stress due to the autofrettage is effective with respect to the internal pressure fatigue strength. Namely, in accordance with the autofrettage processing, since an inner surface layer is slightly processed and hardened, durability is also improved in this respect. Further, when this kind of steel is used, hardness is greatly increased and the internal pressure fatigue strength is increased.

TRIP type bainite steel (TB steel) having components shown in Table 1 is manufactured and a seamless steel pipe (header) having 34 mm in outside diameter, 4.5 mm in wall thickness and 25 mm in inside diameter with respect to size is used. After predetermined pipe extension and annealing are repeated, the steel is changed to austenite for 20 minutes at 950° C. Thereafter, austemper processing for holding the austenite for three minutes in a range of 350 to 475° C. is performed. Thereafter, the final pipe extension processing is performed so that a pipe manufactured by TB steel having 6 mm in outside diameter, 2 mm in wall thickness and 2 mm in inside diameter with respect to the size of a product is obtained. No annealing is performed at the product size, and the product is formed by molding a joint portion and performing bending processing.

The obtained product was preferable in both the internal pressure fatigue resisting characteristics and the vibrational fatigue resisting characteristics by the martensitic transformation induced by the final pipe extension processing. Further, bending shape stable property is also preferable since the TRIP type bainite steel has high deformation ability.

Further, TRIP type bainite steel (TB steel) having components shown in Table 1 is manufactured and a seamless steel pipe (header) having 34 mm in outside diameter, 4.5 mm in wall thickness and 25 mm in inside diameter with respect to size is used. After predetermined pipe extension and annealing are repeated, the final pipe extension processing is performed so that a pipe manufactured by TB steel having 6 mm in outside diameter, 2 mm in wall thickness and 2 mm in inside diameter with respect to the product size is obtained. The obtained pipe manufactured by the TB steel is changed to austenite for 20 minutes at 950° C. Thereafter, austemper processing for holding the austenite for three minutes in a range of 350 to 475° C. is performed. Thereafter, a joint portion is molded and bending processing and autofrettage processing (the internal pressure is 50% of the wall thickness) are performed at the product size.

In this embodiment, the obtained product also has excellent internal pressure fatigue resisting characteristics by the martensitic transformation induced by the final pipe extension processing, and also has a preferable bending shape stable property.

Further, TRIP type bainite steel (TB steel) having components shown in Table 1 is manufactured and a seamless steel pipe (header) having 18 mm in outside diameter, 3.8 mm in wall thickness and 10.4 mm in inside diameter with respect to size is used. Flaw removal processing of the inner surface is performed by cutting processing, and predetermined pipe extension and annealing are repeated. Thereafter, the final pipe extension processing is performed so that a pipe manufactured by TB steel having 6 mm in outside diameter, 1.8 mm in wall thickness and 2.4 mm in inside diameter with respect to the product size is obtained. The obtained pipe manufactured by the TB steel is changed to austenite for 20 minutes at 950° C. Thereafter, austemper processing for holding the austenite for three minutes at a temperature of 400° C. is performed, and the austenite is cooled. Thereafter, outer surface rust prevention processing is performed, and a joint portion is then molded and bending processing is performed at the product size so that the product is formed.

In this embodiment, the obtained product also has excellent internal pressure fatigue resisting characteristics by the martensitic transformation induced by the final pipe extension processing, and also has a preferable bending shape stable property.

After the joint portion is molded or the bending processing is performed at the product size, similar effects are naturally obtained even when cleaning processing of the inner surface is performed.

Further, TRIP type bainite steel (TB steel) having components shown in Table 1 is manufactured and a seamless steel pipe (header) having 18 mm in outside diameter, 3.8 mm in wall thickness and 10.4 mm in inside diameter with respect to size is used. Flaw removal processing of the inner surface is performed by cutting processing. After predetermined pipe extension and annealing are repeated, the final pipe extension processing is performed so that a pipe manufactured by TB steel having 6 mm in outside diameter, 1.8 mm in wall thickness and 2.4 mm in inside diameter with respect to the product size is obtained. The obtained pipe manufactured by the TB steel is changed to austenite for 20 minutes at 950° C. Thereafter, austemper processing for holding the austenite for three minutes at a temperature of 400° C. is performed, and the austenite is cooled. Thereafter, inner surface cleaning processing and outer surface rust prevention processing are performed, and a joint portion is then molded and bending processing and autofrettage processing (the internal pressure is 50% of the wall thickness) are performed at the product size so that the product is formed.

In this embodiment, the obtained product also has excellent internal pressure fatigue resisting characteristics by the martensitic transformation induced by the final pipe extension processing, and also has a preferable bending shape stable property.

For comparison, with respect to a pipe extension finished product manufactured by using the seamless steel pipe manufactured by normal high strength steel (SCM435) (C 0.33 to 0.38 mass %, Si 0.15 to 0.35 mass %, Mn 0.60 to 0.85 mass %, P 0.030 mass % or less, S 0.030 mass % or less, Cr 0.90 to 1.20 mass %, and Mo 0.15 to 0.30 mass %), the molding of a head portion and the bending processing could not be performed by processing-hardening. Further, no bending processing was performed when the normal heat treatment (quenching and tempering) was executed.

TABLE 1

| C | Si | Mn | Al |
|---|---|---|---|
| 0.17 | 1.41 | 2.02 | 0.032 |

(mass %)

As explained above, the high pressure fuel injection pipe in the present invention has high plastic deformation ability and also has a martensite texture by plastic processing. Therefore, the high pressure fuel injection pipe is manufactured by transformation induced plastic type strength steel high in both strength and hardness. Therefore, the entire pipe has high strength and high hardness and is excellent in internal pressure fatigue resisting characteristics, vibrational fatigue resisting characteristics, cavitation resisting property, the flawing resisting property of a sheet face and bending shape stable property. The entire pipe can be also made thin and light in weight.

Further, the high pressure fuel injection pipe has good processability during the processing, and also has a smooth inner surface (having no flaw). Further, since a reduction at the pipe extending time is set to be large, the number of pipe extending times can be reduced. Further, if the reduction is the same, there are effects in that the processing can be performed by a small pipe extending machine and a small die, etc.

1. A high pressure fuel injection pipe in which pipe extension and heat treatment are repeated by using a header manufactured by transformation induced plastic type strength steel, and processing for depositing residual austenite is then performed and final pipe extension processing is performed, and internal pressure and bending fatigue strength are raised by molding a joint portion and performing bending processing without performing perfect annealing at the size of a product.

2. The high pressure fuel injection pipe according to claim 1, wherein the transformation induced plastic type strength steel is ferrite (α_{f})+bainite (α_{b})+γ_{R} composite texture steel [TRIP type Dual-Phase steel, TDP steel], and bainitic ferrite (α_{bf})+γ_{R} steel [TRIP type bainite steel, TB steel] in which press molding property is greatly improved by utilizing strain induced transformation (TRIP) of the residual austenite (γ_{R}).

3. A high pressure fuel injection pipe in which pipe extension and heat treatment are repeated by using a header manufactured by transformation induced plastic type strength steel, and the header is finished at a product size via a final pipe extension process, and processing for depositing residual austenite is then performed, and a joint portion is molded and bending processing is performed, and the inner surface layer of a manufactured pipe body is plastically processed so that a martensitic transformation is induced and high strength is set.

4. The high pressure fuel injection pipe according to claim 3, wherein the transformation induced plastic type strength steel is ferrite (α_{f})+bainite (α_{b})+γ_{R} composite texture steel [TRIP type Dual-Phase steel, TDP steel], and bainitic ferrite (α_{bf})+γ_{R} steel [TRIP type bainite steel, TB steel] in which press molding property is greatly improved by utilizing strain induced transformation (TRIP) of the residual austenite (γ_{R}).

5. The high pressure fuel injection pipe according to claim 3, wherein only the inner circumferential surface is plastically deformed (autofrettage-processed) by applying internal pressure in the plastic processing.

6. A high pressure fuel injection pipe in which flaw removal processing on the inner surface of a steel pipe having a transformation induced plastic type strength steel component and pipe extension processing are performed, and the steel pipe is finished at a predetermined desirable size and is then heated to 950° C. and is set to an austenite single layer and is then suddenly cooled, and austemper processing is performed at 350 to 500° C., and the inner surface is smoothed after the cooling, and a joint portion is then molded and bending processing is performed so that internal pressure and bending fatigue strength are raised.

7. The high pressure fuel injection pipe according to claim 6, wherein the transformation induced plastic type strength steel is ferrite (α_{f})+bainite (α_{b})+γ_{R} composite texture steel [TRIP type Dual-Phase steel, TDP steel], and bainitic ferrite (α_{bf})+γ_{R} steel [TRIP type bainite steel, TB steel] in which press molding property is greatly improved by utilizing strain induced transformation (TRIP) of the residual austenite (γ_{R}).

8. The high pressure fuel injection pipe according to claim 6, wherein cleaning processing of the inner surface is performed at least once after the smoothing of the inner surface, the molding of the joint portion, or the bending processing.

9. A high pressure fuel injection pipe in which flaw removal processing on the inner surface of a steel pipe having a transformation induced plastic type strength steel component and pipe extension processing are performed, and the steel pipe is finished at a predetermined desirable size and is then heated to 950° C. and is set to an austenite single layer and is then suddenly cooled, and austemper processing is performed at 350 to 500° C., and the inner surface is smoothed after the cooling, and a joint portion is then molded and bending processing is performed, and plastic processing is further performed after said bending processing so that a martensitic transformation is induced and high strength is set.

10. The high pressure fuel injection pipe according to claim 9, wherein the transformation induced plastic type strength steel is ferrite (α_{f})+bainite (α_{b})+γ_{R} composite texture steel [TRIP type Dual-Phase steel, TDP steel], and bainitic ferrite (α_{bf})+γ_{R} steel [TRIP type bainite steel, TB steel] in which press molding property is greatly improved by utilizing strain induced transformation (TRIP) of the residual austenite (γ_{R}).

11. The high pressure fuel injection pipe according to claim 9, wherein only the inner circumferential surface is plastically deformed (autofrettage-processed) by applying internal pressure in the plastic processing.

12. The high pressure fuel injection pipe according to claim 9, wherein cleaning processing of the inner surface is performed at least once after the smoothing of the inner surface, the molding of the joint portion, or the bending processing.
